(19) United States
(12) Patent Application Publication
(10) Pub. No.: US 2020/0138174 A1
(43) Pub. Date: May 7, 2020

(54) Mobile Phone Buckling Structure and Mobile Phone Fixing Device

(71) Applicant: Shenzhen Zhiyuan Tongtai Technology Co., Ltd., Shenzhen, Guangdong (CN)

(72) Inventor: HAIBO QI, Shenzhen, Guangdong (CN)

(21) Appl. No.: 15/580,679

(22) PCT Filed: Apr. 7, 2017
(86) PCT No.: PCT/CN2017/079769

§ 371 Date: Dec. 7, 2017

(30) Foreign Application Priority Data
Mar. 7, 2017 (CN) 201720228771.5

(51) Int. Cl. A45F 5/00; H04B 1/3877; H04M 1/725; H04B 1/3827; A44B 17/00

(52) U.S. Cl. CPC A45F 5/00; H04B 1/3877; H04M 1/725; A45F 2200/0516; A44B 17/0011; H04B 2001/3855; H04B 1/385

(57) ABSTRACT

The present invention discloses a mobile phone buckling structure and a mobile phone fixing device. The mobile phone buckling structure comprises a first housing, a transmission part and a button. A cavity is formed inside the first housing; a first guide slot and a second guide slot are formed in the cavity; a first movable buckle is movably arranged in the first guide slot; a second movable buckle is movably arranged in the second guide slot; a first elastic element is arranged between the bottom ends of the first movable buckle and first guide slot; a second elastic element is arranged between the bottom ends of the second movable buckle and second guide slot; a first slot matched with one end of the first movable buckle is formed at the first side of the transmission part; a second slot matched with one end of the second movable buckle is formed at the second side of the transmission part; a third elastic element is arranged between the third side of the transmission part and the inner wall of the cavity; the fourth side of the transmission part is connected with a button movably arranged in a through hole of the first housing. The present invention can quickly realize the fixing and separation of the mobile phone, and can also be operated by one hand.

### TECHNICAL FIELD

The present invention relates to the field of mobile phone accessories, in particular to a mobile phone buckling structure and a mobile phone fixing device.

### BACKGROUND OF THE PRESENT INVENTION

When people go out to exercise, in order to conveniently carry mobile phones to free hands and pockets, the mobile phones are usually fixed by waist clip, arm clip and bicycle clip. However, problems exist in the existing mobile phone waist clip, arm clip and bicycle clip on the market, such as the mobiles is unstable and easy to fall off after being buckled, and the buckling and separation of mobile phone are inconvenient to be operated quickly or by one hand.

### SUMMARY OF THE PRESENT INVENTION

The present invention provides a mobile phone buckling structure and mobile phone fixing device, to solve the inconvenient fast or one-hand operation of the mobile phone buckling structure in the prior art.

To solve the above-mentioned problems, a mobile phone buckling structure is provided as an aspect of the. The mobile phone buckling structure comprises a first housing, a transmission part and a button. A cavity is formed inside the first housing; a first guide slot and a second guide slot are formed in the cavity; a first movable buckle is movably arranged in the first guide slot; a second movable buckle is movably arranged in the second guide slot; a first elastic element is arranged between the bottom ends of the first movable buckle and first guide slot; a second elastic element is arranged between the bottom ends of the second movable buckle and second guide slot; and the first movable buckle and the second movable buckle are arranged along a first straight line; a first slot matched with one end of the first movable buckle is formed at the first side of the transmission part; a second slot matched with one end of the second movable buckle is formed at the second side of the transmission part; a third elastic element is arranged between the third side of the transmission part and the inner wall of the cavity; the fourth side of the transmission part is connected with a button movably arranged in a through hole of the first housing; the third elastic element and the button are arranged along a second straight line perpendicular to the first straight line.

Preferably, one end of the third elastic element is abutted against the inner wall of the cavity, and the other end is sheathed on a fixed column at the third side of the transmission part.

Preferably, the cross sections of the first slot and the second slot are both trapezoidal, and the cross sections of said one end of the first mobile card buckle and said one end of the second movable buckle are both trapezoidal.

Preferably, a sliding positioning slot is formed in the middle of the transmission part; a protrusion inwardly recessed in the cavity is formed at one side of the first housing; the protrusion is located in the sliding positioning slot.

Preferably, a first opening for protruding the first movable buckle and a second opening for protruding the second movable buckle are formed on the side wall of the protrusion.

Preferably, a fixing hole for fixing the first elastic element is formed in the first movable buckle, and a fixing hole for fixing the second elastic element is formed in the second movable buckle.

Preferably, the mobile phone buckling structure further comprises a mobile phone buckle connected with a mobile phone to be fixed or the protective sheath of the mobile phone to be fixed; a slot A for matching with the first movable buckle and a slot B for matching with the second movable buckle are arranged in the circumferential direction of the mobile phone buckle.

Preferably, the mobile phone buckling structure further comprises a magnet for adsorbing the mobile phone buckle, and the magnet is mounted on the bottom surface of the protrusion.

The present invention further provides a mobile phone fixing device, comprising the above-mentioned mobile phone buckling structure.

Preferably, the mobile phone fixing device is a mobile phone waist clip, a mobile phone arm clip or a mobile phone bicycle clip.

As a result of the above technical solutions, the present invention can conveniently and quickly achieve the fixation and separation of mobile phones as well as one-hand operation; there is no need to worry about that the mobile phone will fall or easy to pull off after being buckled. the present invention has features of low structure and low cost.

### DESCRIPTION OF THE DRAWINGS

FIG. 1 schematically shows a structural diagram of the mobile phone waist clip of the present invention;

FIG. 2 schematically shows a structural diagram of the mobile phone arm clip of the present invention;

FIG. 3 schematically shows a structural diagram of the mobile phone bicycle clip of the present invention;

FIG. 4 schematically shows a schematic diagram of connection between the mobile phone and mobile phone buckle;

FIG. 5 schematically shows a front view of the mobile phone buckling structure;

FIG. 6 schematically shows a schematic diagram of installation between the mobile phone buckling structure and mobile phone buckle;

FIG. 7 schematically shows an exploded view of the mobile phone buckling structure;

FIG. 8 schematically shows a sectional view of the mobile phone buckling structure along one direction;

FIG. 9 schematically shows a sectional view of the mobile phone buckling structure along the other direction;

FIG. 10 schematically shows a schematic diagram of the internal structure of the mobile phone buckling structure;

FIG. 11 schematically shows a rear view of the mobile phone buckling structure;

FIG. 12 schematically shows a schematic diagram of connection between the mobile phone buckle and protective sheath.

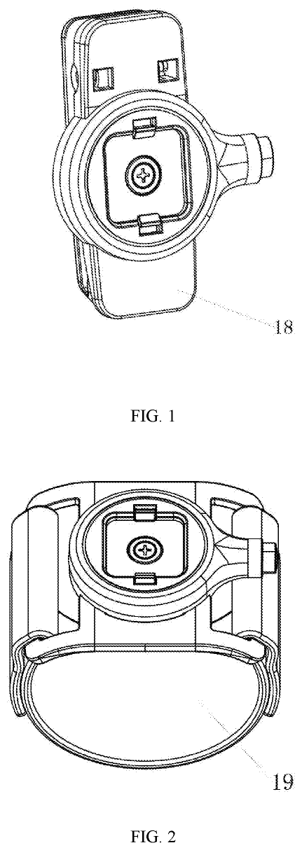

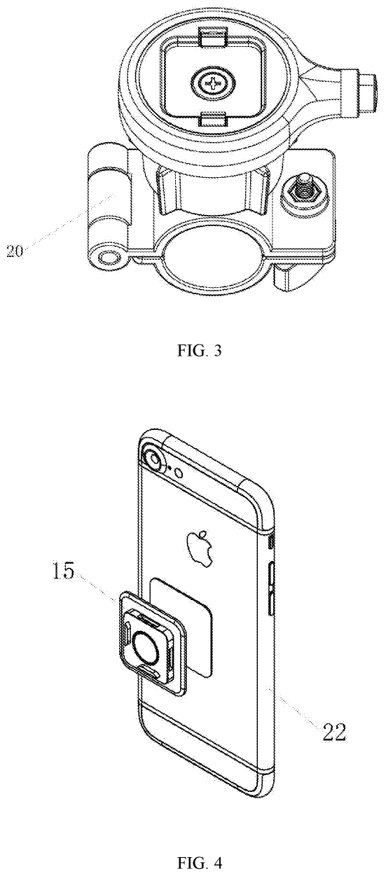

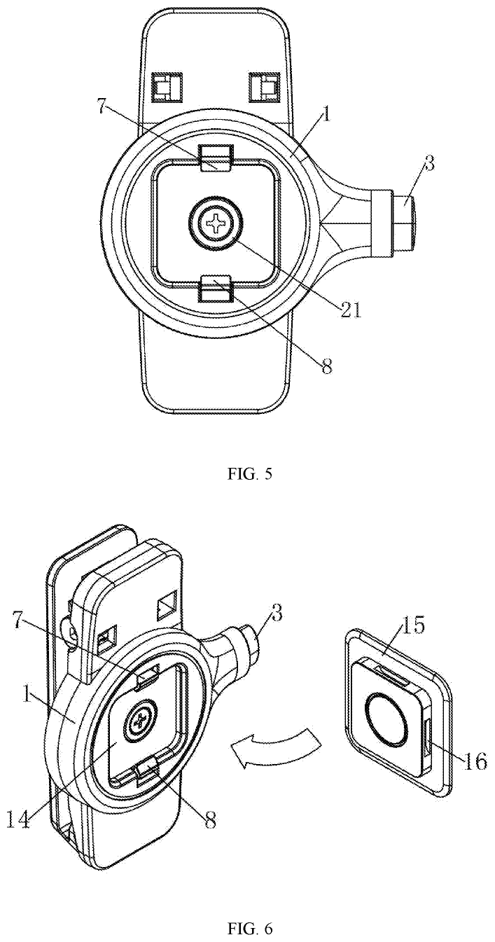

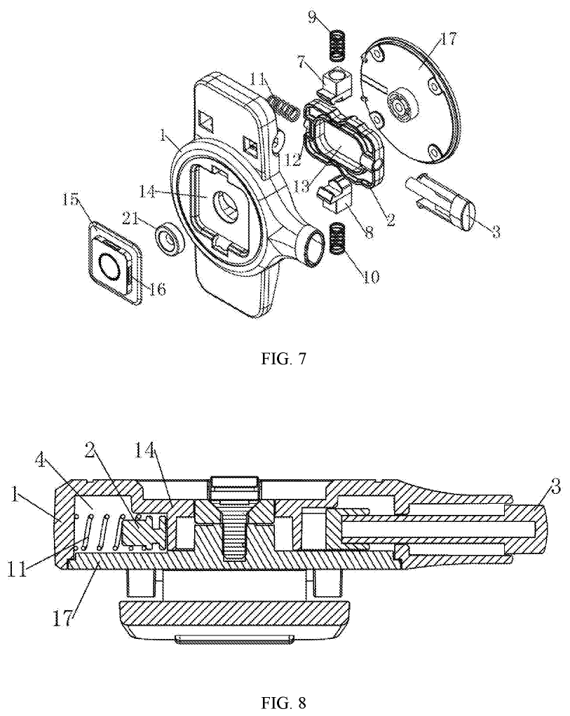

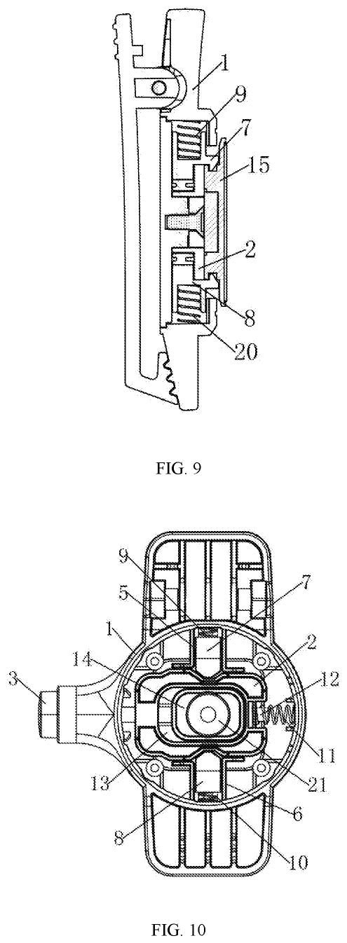

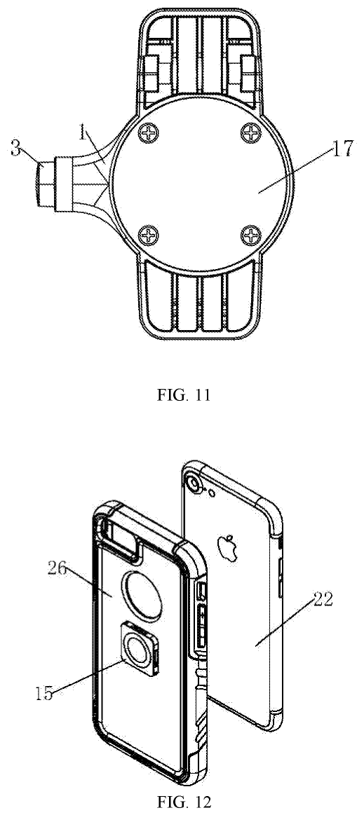

Reference numerals: 1, first housing; 2, transmission part; 3, button; 4, cavity; 5, first guide slot; 6, second guide slot; 7, first movable buckle; 8, second movable buckle; 9, first elastic element; 10, second elastic element; 11, third elastic element; 12, fixed column; 13, sliding positioning slot; 14, protrusion; 15, mobile phone buckle; 16, slot A; 17, second housing; 18, mobile phone waist clip; 19, mobile phone arm clip; 20, mobile phone bicycle clip; 21, magnet; 22, mobile phone; 23, protrusion; 24, depression; 25, protective sheath.

### DETAILED DESCRIPTION OF THE PREFERRED EMBODIMENTS

The embodiments of the present invention are described in detail as follows with reference to the drawing, but the present invention can be implemented in many different ways as defined and covered by the claims.

The present invention discloses a mobile phone buckling structure, comprising a first housing 1, a transmission part 2 and a button 3, wherein a cavity 4 is formed inside the first housing 1; a first guide slot 5 and a second guide slot 6 are formed in the cavity 4; a first movable buckle 7 is movably arranged in the first guide slot 5; a second movable buckle 8 is movably arranged in the second guide slot 6; a first elastic element 9 is arranged between the bottom ends of the first movable buckle 7 and first guide slot 5; a second elastic element 10 is arranged between the bottom ends of the second movable buckle 8 and second guide slot 6; and the first movable buckle 7 and the second movable buckle 8 are arranged along a first straight line; a first slot matched with one end of the first movable buckle 7 is formed at the first side of the transmission part 2; a second slot matched with one end of the second movable buckle 8 is formed at the second side of the transmission part 2; a third elastic element 11 is arranged between the third side of the transmission part 2 and the inner wall of the cavity 4; the fourth side of the transmission part 2 is connected with a button 3 movably arranged in a through hole of the first housing 1; the third elastic element 11 and the button 3 are arranged along a second straight line perpendicular to the first straight line. Preferably, the first movable buckle 7 and the second movable buckle 8 made from hardware materials.

In use, the first elastic element 9 and the second elastic element 10 provide an elastic force for the first movable buckle 7 and the second movable buckle 8 respectively, so that the first movable buckle 7 and the second movable buckle 8 have a tendency to move towards each other, thereby buckling the mobile phone to be fixed. At this point, one ends of the first movable buckle 7 and the second movable buckle 8 are respectively stuck in the first slot and the second slot.

When the mobile phone needs to be released, the button 3 can be pressed, so that the transmission part 2 moves in the direction perpendicular to the first straight line, and the first movable buckle 7 and second movable buckle 8 move away from each other and open under the action of the included side wall of the first slot and the second slot, thereby releasing the gripping of the mobile phone. When the press on the button is released, the transmission part 2 conducts return motion in the direction of the button 3, so that one ends of the first movable buckle 7 and the second movable buckle 8 are respectively stuck in the first slot and the second card.

As a result of the above technical solutions, the present invention can conveniently and quickly achieve the fixation and separation of mobile phones as well as one-hand operation; there is no need to worry about that the mobile phone will fall or easy to pull off after being buckled. the present invention has features of low structure and low cost.

Preferably, one end of the third elastic element 11 is abutted against the inner wall of the cavity 4, and the other end is sheathed on a fixed column 12 at the third side of the transmission part 2.

Preferably, the cross sections of the first slot and the second slot are both trapezoidal, and the cross sections of said one end of the first mobile card buckle 7 and said one end of the second movable buckle 8 are both trapezoidal.

Preferably, a sliding positioning slot 13 is formed in the middle of the transmission part 2; a protrusion 14 inwardly recessed in the cavity 4 is formed at one side of the first housing 1; the protrusion 14 is located in the sliding positioning slot 13.

Preferably, a first opening for protruding the first movable buckle 7 and a second opening for protruding the second movable buckle 8 are formed on the side wall of the protrusion 14. In one embodiment, the opposite ends of the first movable buckle 7 and the second movable buckle 8 are formed with buckle bulges; the first movable buckle 7 and the second movable buckle 8 are respectively hooked at the corresponding positions corresponding to the first opening and the second opening; to facilitate the assembly and guide, the raised head of buckle bulges of the first movable buckle 7 and the second movable buckle 8 are provided with an oblique angle.

Preferably, a fixing hole for fixing the first elastic element 9 is formed in the first movable buckle 7, and a fixing hole for fixing the second elastic element 10 is formed in the second movable buckle 8.

Preferably, the mobile phone buckling structure further comprises a mobile phone buckle 15 connected with a mobile phone to be fixed or the protective sheath of the mobile phone to be fixed; a slot A 16 for matching with the first movable buckle 7 and a slot B for matching with the second movable buckle 8 are arranged in the circumferential direction of the mobile phone buckle 15. As shown in FIG. 6, a protrusion 23 is formed on one side of the mobile phone buckle 15 toward the first housing 1, and corresponds to a depression 24 formed on the protrusion 14 of the first housing 1 toward the mobile phone buckle 15. During installation, the protrusion 23 is placed in the depression 24, and the first movable buckle 7 and the second movable buckle 8 are stuck in the slot A and slot B. As shown in FIG. 12, the mobile phone buckle 15 is fixedly installed on the back of the protective sheath 25. The mobile phone 22 is installed on the front of the protective sheath 25. Preferably, the mobile phone buckle 15 is made from hardware material.

Preferably, the mobile phone buckling structure further comprises a second housing 17 connected with the first housing 1; the second housing 17 is covered at the opening of the cavity 4.

Preferably, the mobile phone buckling structure further comprises a magnet 21 for adsorbing the mobile phone buckle 15, and the magnet 21 is mounted on the bottom surface of the protrusion 14. During installation, the mobile phone buckle 15 can be adsorbed by the magnet 21, to achieve the purpose of adsorbing the mobile phone; at the same time, the first movable buckle 7 and the second movable buckle 8 are stuck in the slot A and slot B.

The present invention further provides a mobile phone fixing device, comprising the above-mentioned mobile phone buckling structure. Preferably, the mobile phone fixing device is a mobile phone waist clip 18, a mobile phone arm clip 19 or a mobile phone bicycle clip 20.

The above description is only the preferred embodiment of the present invention, and is not intended to limit the scope of the present invention; for the person skilled in the art, the present invention may have various changes and variations. Any modification, equivalent replacement and improvement within the spirit and principles of the present invention shall be covered by the protection scope of the present invention.

1. A mobile phone buckling structure, comprising a first housing (1), a transmission part (2) and a button (3), wherein
a cavity (4) is formed inside the first housing (1); a first guide slot (5) and a second guide slot (6) are formed in the cavity (4);
a first movable buckle (7) is movably arranged in the first guide slot (5); a second movable buckle (8) is movably arranged in the second guide slot (6); a first elastic element (9) is arranged between the bottom ends of the first movable buckle (7) and first guide slot (5); a second elastic element (10) is arranged between the bottom ends of the second movable buckle (8) and second guide slot (6); and the first movable buckle (7) and the second movable buckle (8) are arranged along a first straight line;
a first slot matched with one end of the first movable buckle (7) is formed at the first side of the transmission part (2); a second slot matched with one end of the second movable buckle (8) is formed at the second side of the transmission part (2); a third elastic element (11) is arranged between the third side of the transmission part (2) and the inner wall of the cavity (4); the fourth side of the transmission part (2) is connected with a button (3) movably arranged in a through hole of the first housing (1); the third elastic element (11) and the button (3) are arranged along a second straight line perpendicular to the first straight line.

2. The mobile phone buckling structure according to claim 1, wherein one end of the third elastic element (11) is abutted against the inner wall of the cavity (4), and the other end is sheathed on a fixed column (12) at the third side of the transmission part (2).

3. The mobile phone buckling structure according to claim 1, wherein the cross sections of the first slot and the second slot are both trapezoidal, and the cross sections of said one end of the first mobile card buckle (7) and said one end of the second movable buckle (8) are both trapezoidal.

4. The mobile phone buckling structure according to claim 1, wherein a sliding positioning slot (13) is formed in the middle of the transmission part (2); a protrusion (14) inwardly recessed in the cavity (4) is formed at one side of the first housing (1); the protrusion (14) is located in the sliding positioning slot (13).

5. The mobile phone buckling structure according to claim 4, wherein a first opening for protruding the first movable buckle (7) and a second opening for protruding the second movable buckle (8) are formed on the side wall of the protrusion (14).

6. The mobile phone buckling structure according to claim 5, wherein a fixing hole for fixing the first elastic element (9) is formed in the first movable buckle (7), and a fixing hole for fixing the second elastic element (10) is formed in the second movable buckle (8).

7. The mobile phone buckling structure according to claim 6, wherein the mobile phone buckling structure further comprises a mobile phone buckle (15) connected with a mobile phone to be fixed or the protective sheath of the mobile phone to be fixed; a slot A (16) for matching with the first movable buckle (7) and a slot B for matching with the second movable buckle (8) are arranged in the circumferential direction of the mobile phone buckle (15).

8. The mobile phone buckling structure according to claim 7, wherein the mobile phone buckling structure further comprises a magnet (21) for adsorbing the mobile phone buckle (15), and the magnet (21) is mounted on the bottom surface of the protrusion (14).

9. A mobile phone fixing device, comprising the mobile phone buckling structure according to any one of claims 1 to 8.

10. The mobile phone fixing device according to claim 9, wherein the mobile phone fixing device is a mobile phone waist clip (18), a mobile phone arm clip (19) or a mobile phone bicycle clip (20).
